(19) United States
(12) Patent Application Publication
(10) Pub. No.: US 2019/0254897 A1
(43) Pub. Date: Aug. 22, 2019

(54) HOSPITAL/MEDICAL BED WITH INTEGRATED BEDPAN SYSTEM

(71) Applicant: Mary Tewes, Manhattan, IL (US)

(72) Inventor: Mary Tewes, Manhattan, IL (US)

(21) Appl. No.: 15/902,104

(22) Filed: Feb. 22, 2018

(51) Int. Cl. A61G 7/02; A61G 7/015; A61G 7/018

(52) U.S. Cl. CPC A61G 7/02; A61G 7/018; A61G 7/015

(57) ABSTRACT

An automated bedpan system integrated into a hospital bed comprising a hospital bed comprising a bed frame covered by a mattress. The mattress comprises a movable mattress section moved into and through a longitudinal covered, internal slot integrated into the mattress and an electric motor powering a mattress track system to move said moveable mattress section. The moveable mattress section functions to cover a portal in the mattress that can be opened and closed by the mattress track system. A bedpan movement system comprising a lift system for moving the bedpan up and down to the portal for patient use powered by an electric motor.

CROSS-REFERENCE TO RELATED APPLICATION(S)

Not applicable.

### BACKGROUND OF THE INVENTION

### 1. Field of Invention

The present invention relates to the field hospital/medical bed, more particularly to a hospital/medical bed mattress having an integrated bedpan system for automatic positioning under a patient.

### 2. Description of Related Art

Patients confined to a hospital or medical bed while recovering from an illness, surgery, or injury can face many challenges. A big challenge for anyone confined to a bed for a prolonged period of time remains bodily functions. Defecating and urinating can present significant problems. Problems that inevitably arise include lifting the patient onto a bedpan, keeping the patient clean as they repeatedly defecate while confined to their bed, moving the bed and patient to facilitate voiding into the bedpan, patients waiting for kelp to void (which can involve 4 to 6 people rolling the patient around on broken bones to clean them and the bed), and inflicted pain.

Based on the foregoing, there is a need in the art a system for moving and positioning a bedpan in a hospital/medical bed to facilitate a patient's defecating and urinating.

### SUMMARY OF THE INVENTION

An automated bedpan system integrated into a hospital bed comprising a hospital bed comprising a bed frame covered by a mattress. The mattress comprises a movable mattress section moved into and through a longitudinal covered, internal slot integrated into the mattress and an electric motor powering a mattress track system to move said moveable mattress section. The moveable mattress section functions to cover a portal in the mattress that can be opened and closed by the mattress track system. A bedpan movement system comprising a lift system for moving the bedpan up and down to the portal for patient use powered by an electric motor.

The bedpan movement system further comprises a lateral bedpan track system for moving the bedpan laterally for access by a caregiver.

The bedpan movement system is integrated into the mattress, and the mattress further comprises a slot in the side associated with the bedpan movement system.

The bedpan movement system is integrated into an underside of the frame with a bedpan hole in the frame to accommodate raising and lowering the bedpan through the portal of the mattress.

The moveable mattress section comprises a block of mattress foam.

The moveable mattress section comprises a block of reinforced mattress foam about 8½ inches wide, 12 inches long, and 4½ inches high.

The bedpan comprises a removable plastic liner facilitating cleanup after use.

A fitted cover sheet with an elasticized opening fitting over the portal in the mattress.

The moveable mattress section stows inside the covered, internal slot during bedpan use.

The mattress comprises a reinforced box section that supports and secures the mechanical components of the movable mattress section, the covered, internal slot, and the mattress track system that opens and closes the bedpan portal.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a top view of the basic components of the mattress, according to an embodiment of the present invention;

FIG. 2 is a perspective view of the basic components of the mattress, according to an embodiment of the present invention;

FIG. 3 is a perspective view of an alternative embodiment of a bedpan system, according to an embodiment of the present invention;

FIG. 4 is a perspective view of the moveable mattress section, according to an embodiment of the present invention;

FIG. 5 is a perspective view of the bedpan, according to an embodiment of the present invention;

FIG. 6 is a side view of the center of the mattress, according to an embodiment of the present invention; and

FIG. 7A and B are perspective views of the mattress with a fitted cover sheet, according to an embodiment of the present invention.

### DETAILED DESCRIPTION OF PREFERRED EMBODIMENTS

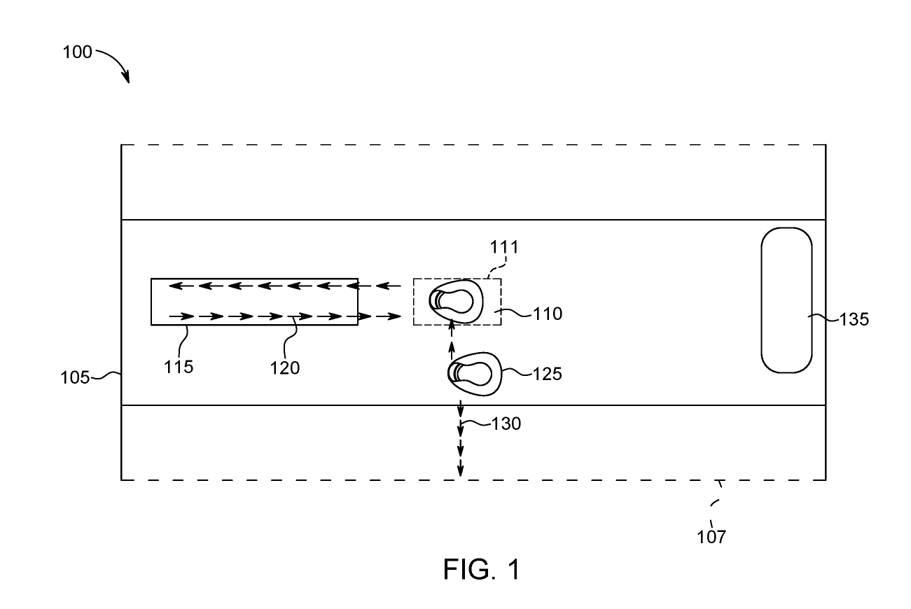

Preferred embodiments of the present invention and their advantages may be understood by referring to FIGS. 1-7B, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 depicts the basic components of the invention in a top view of a mattress. Hospital/medical mattress 100 includes a central mechanical section 105 housing mechanical components and an outer conventional mattress section 107 on each side. Central mechanical section 105 can essentially comprise a reinforced box section that supports and secures mechanical components a movable mattress section 110 that can move along a covered internal slot 115 using mattress track system 120 opening and closing bedpan portal 111. The central mechanical section 105 can also include a bedpan 125 that can be elevated after moving mattress section 105 along mattress track system 120 through a created opening or portal in central mechanical section 105. A bedpan track system 130 can move the bedpan laterally for removal. Standard mattress size can be about 36 inches wide and 80 inches long.

In an embodiment, the bedpan 125 can be positioned underneath the moving mattress section 105. When needed, the moving mattress section 105 can be operated to move by mattress track system 120 along the covered internal slot 115, exposing the retracted bedpan 125. A bedpan lift system can raise the bedpan 125 into position for use and lower the bedpan 125 after use. Bedpan 125 can include a plastic liner to contain urine and stool for easy cleanup.

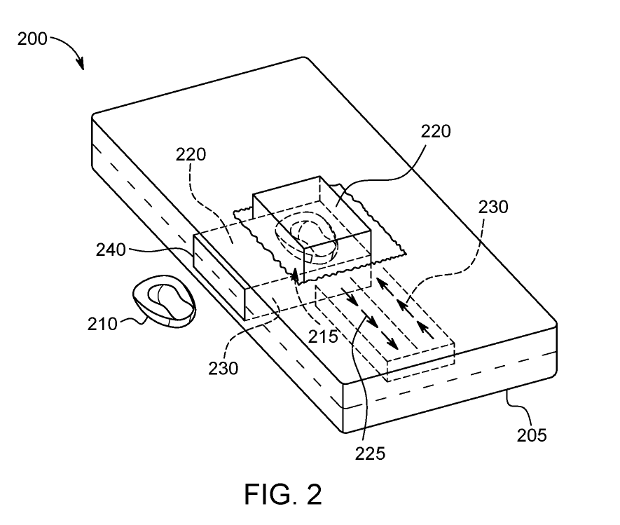

FIG. 2 depicts a perspective view of a mattress with the components of the invention. Hospital/medical mattress 200 includes mattress 205. Bedpan 210 can be inserted into mattress 205 through bedpan access slot 240 to engage with bedpan track system 220 along a bedpan tunnel 230. A bedpan lift system 215 can raise and lower bedpan 210 for use by an occupant of hospital/medical mattress 200. Movable mattress section 220 can move using mattress track system 225 along covered internal slot 230.

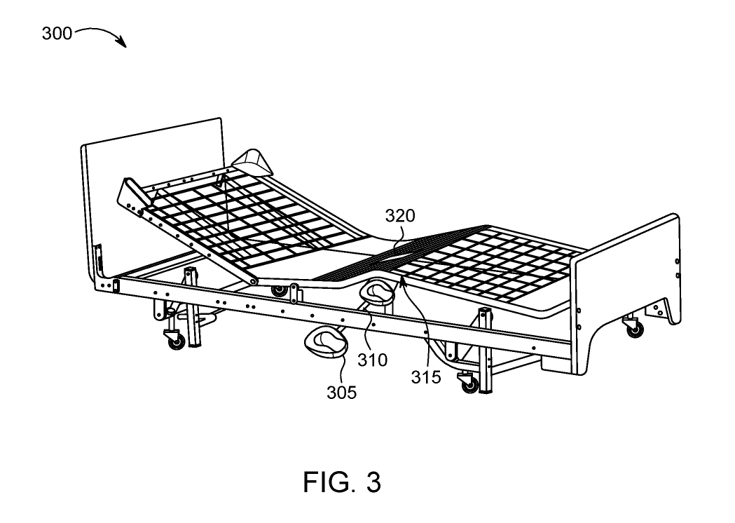

FIG. 3 depicts an alternative embodiment of the bedpan system integrated in the bedframe rather than the mattress. In the embodiment, bedframe 300 includes bedpan 305 that can move along bedpan track system 310, and bedpan lift system 315 can raise and lower bedpan 305 for use. A bedpan hole 320 in bedframe 300 can permit bedpan lift system 315 to raise and lower bedpan 320 through a mattress for use.

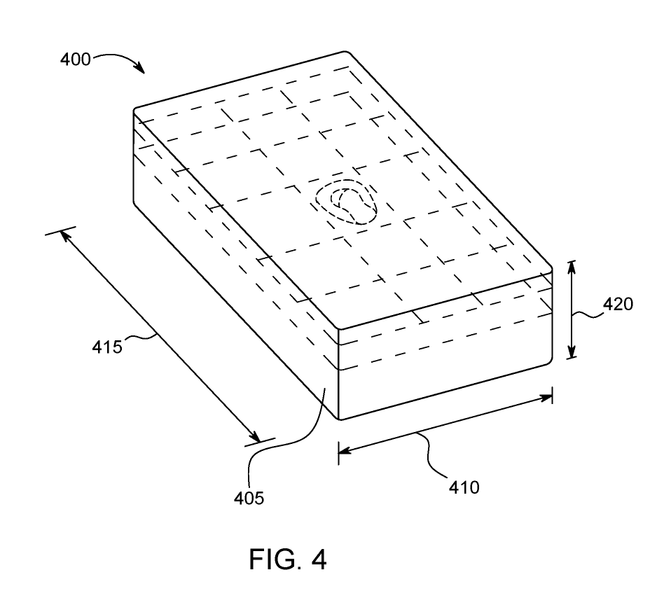

FIG. 4 shows details of the moving mattress section 400. Moving mattress section 400 can be covered by a small fitted sheet 405. The moving mattress section 400 can have a width 410 of about 8½ inches and a length 415 of about 12 inches with a height 420 of about 4½ inches. In an embodiment, the moving mattress section 400 can be constructed from egg crate foam. Movable mattress section 400 can move along track system 120 and be stowed in covered internal slot 115 while the bedpan 125 is used. The movable mattress section 400 can be stowed in the covered internal slot 115 during use. The bedpan 125 rises on the bedpan lift system 215, which can be sturdy enough to support a patient. The patient does not need to move. An aide can use a cleaning wipe to clean the patient.

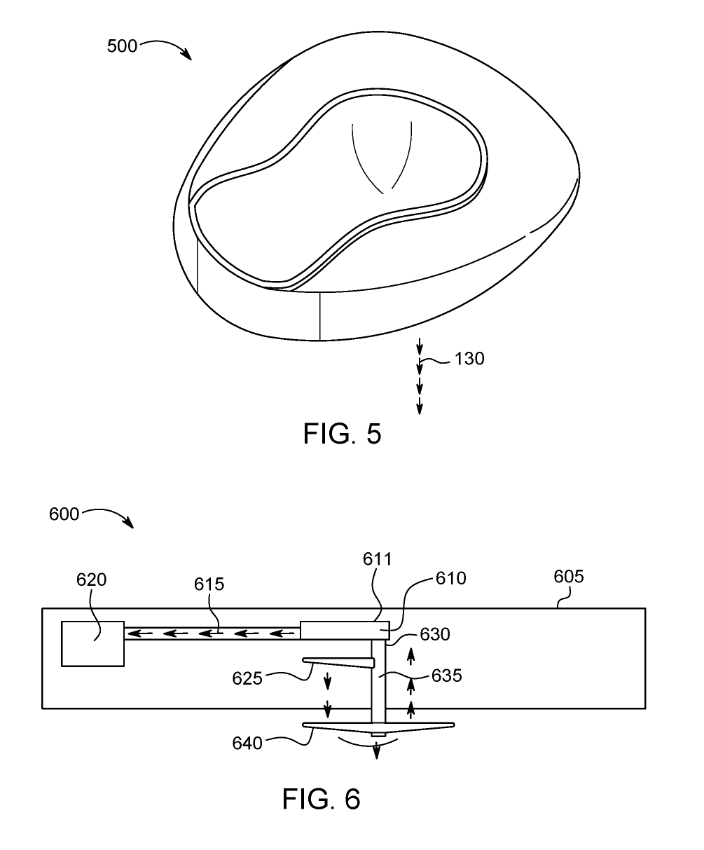

FIG. 5 shows a bedpan 500 useable in the invention. Bedpan 500 comprises a standard stainless steel bedpan. Bedpan 500 can include a plastic liner into which a user defecates and urinates making cleanup very easy.

In an embodiment, bedpan 500 can be secured to bedpan track system 130 using four bolts on the bottom.

FIG. 6 shows a side view of the mattress through the center with major components 600. Hospital/medical mattress 605 includes a moving mattress section 610 and bedpan portal 611 for elevating the bedpan 500 through for use. Mattress track system 615 can transport movable mattress section longitudinally through a slot in the mattress 605, which is operated by track mechanical system 620. Track mechanical system 620 can comprise an electric motor. Bedpan 625 can be raised or lowered through portal 611 by bedpan lift system 630, which can operate by hydraulics or mechanical gear means. Bedpan track system 635 can move the bedpan 625 in and out of mattress 605 through bedpan access slot 640.

After bedpan 625 use, the bedpan 625 can be lowered by bedpan lift system 630 and moved laterally within the mattress using bedpan track system 635 out to bedpan access slot 640 for cleaning and reuse. The bedpan 625 with plastic liner can rest either within mattress 605 or under bed frame 300 (see FIG. 3) while not in use. When needed, the bedpan moves into position by bedpan lift system 630 after the mattress track system 615 moves the moving mattress section 610 to open portal 611 for the bedpan 640 to be elevated. The patient can operate the system by pressing a control button. After use, an aide can easily change the plastic liner on the exposed bedpan 625.

When finished with voiding, a patient can press a control button to operate the system. The bedpan 625 moves out to where an aide can empty the plastic liner. The clean bedpan 625 is then ready for reuse.

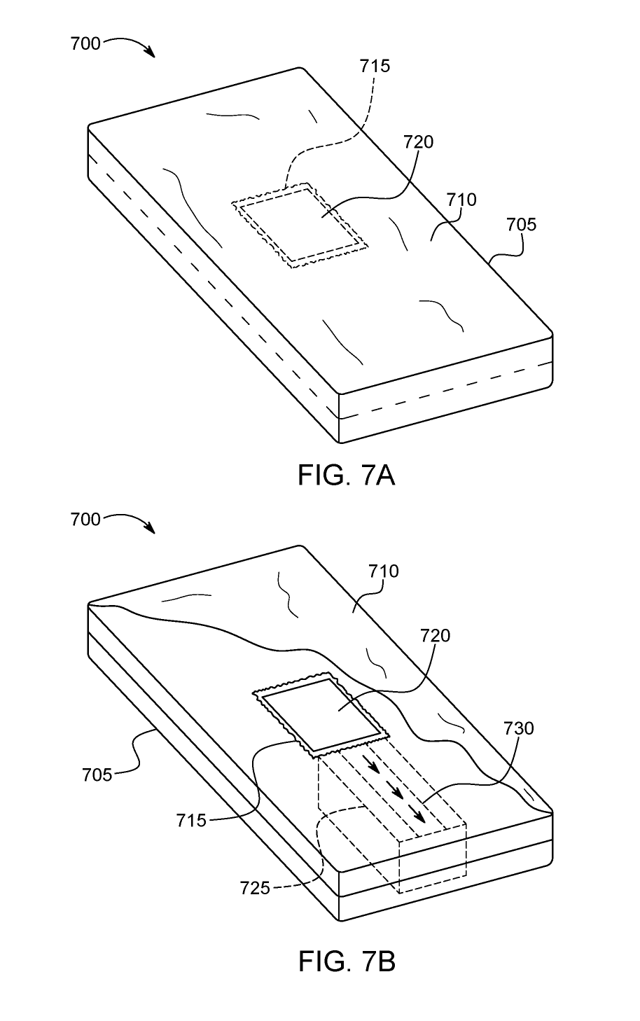

FIG. 7A shows hospital/medical mattress 705 covered by fitted cover sheet 710. An elasticized border 715 surrounds movable mattress section 720. The fitted cover sheet 710 fits onto mattress 705 with an elasticized border fitting over the mattress 705. The fitted sheet 710 includes an elasticized border 715 around the movable mattress section 720. FIG. 7B shows the mattress 700 with a cutaway section of the fitted cover sheet 710. Also depicted is covered internal slot 725 within which the movable mattress section 720 can travel using mattress track system 730.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An automated bedpan system integrated into a hospital bed, comprising:
a hospital bed comprising a bed frame covered by a mattress;
the mattress comprised of a movable mattress section moved into and through a longitudinal covered, internal slot integrated into the mattress and an electric motor powering a mattress track system to move said moveable mattress section;
said moveable mattress section functioning to cover a portal in the mattress that can be opened and closed by the mattress track system; and
a bedpan movement system comprising a lift system for moving the bedpan up and down to the portal for patient use powered by an electric motor.

2. The automated bedpan system integrated into a hospital bed of claim 1, wherein the bedpan movement system further comprises a lateral bedpan track system for moving the bedpan laterally for access by a caregiver.

3. The automated bedpan system integrated into a hospital bed of claim 2, wherein the bedpan movement system is integrated into the mattress; and
the mattress further comprises a slot in the side associated with the bedpan movement system.

4. The automated bedpan system integrated into a hospital bed of claim 2, wherein the bedpan movement system is integrated into an underside of the frame with a bedpan hole in the frame to accommodate raising and lowering the bedpan through the portal of the mattress.

5. The automated bedpan system integrated into a hospital bed of claim 1, wherein the moveable mattress section comprises a block of mattress foam.

6. The automated bedpan system integrated into a hospital bed of claim 5, wherein the moveable mattress section comprises a block of reinforced mattress foam about 8½ inches wide, 12 inches long, and 4½ inches high.

7. The automated bedpan system integrated into a hospital bed of claim 1, wherein the bedpan comprises a removable plastic liner facilitating cleanup after use.

8. The automated bedpan system integrated into a hospital bed of claim 1, further comprising a fitted cover sheet with an elasticized opening fitting over the portal in the mattress.

9. automated bedpan system integrated into a hospital bed of claim 1, wherein the moveable mattress section stows inside the covered, internal slot during bedpan use.

10. The automated bedpan system integrated into a hospital bed of claim 1, wherein the mattress comprises a reinforced box section that supports and secures the mechanical components of the movable mattress section, the covered, internal slot, and the mattress track system that opens and closes the bedpan portal.
